(19) United States
(12) Patent Application Publication
(10) Pub. No.: US 2011/0149678 A1
(43) Pub. Date: Jun. 23, 2011

(54) Methods of and Systems for Improving the Operation of Electric Motor Driven Equipment

(76) Inventors: Kenneth J. SOUTHWICK, Pembroke, MA (US); Renato VALDES, West Roxbury, MA (US)

(21) Appl. No.: 12/900,813

(22) Filed: Oct. 8, 2010

Related U.S. Application Data
(60) Provisional application No. 61/250,204, filed on Oct. 9, 2009.
(60) Provisional application No. 61/289,909, filed on Dec. 23, 2009.
(60) Provisional application No. 61/378,582, filed on Aug. 31, 2010.

(51) Int. Cl. H02P 27/06; H02P 5/74; B01F 7/00

(52) U.S. Cl. 366/302; 318/503; 318/67

(57) ABSTRACT

A method of operating a motor is disclosed. The motor has a nameplate operating frequency and at least a first and second wiring configuration for operating at a first nameplate voltage and second, higher, nameplate voltage, respectively. The method includes operating the motor in the first configuration at a frequency and a voltage based on a set of frequency versus voltage ratios over a range of frequencies. A first ratio in a lower portion of the frequency range is lower than a second ratio in a middle portion of the frequency range. A third ratio in an upper portion of the frequency range is lower than the second ratio. The range of frequencies extends from a value below the nameplate frequency to a value above the nameplate frequency. The corresponding range of voltages extends from a value below the first nameplate voltage to a value above the first nameplate voltage.

### CROSS-REFERENCES TO RELATED APPLICATIONS

This application claims the benefit under 35 U.S.C. §119(e) of the following applications, the contents of which are incorporated by reference herein:
U.S. Provisional Patent Application Ser. No. 61/250,204, entitled Methods of and Systems for Improving the Operation of a Collider Chamber Apparatus, filed Oct. 9, 2009,
U.S. Provisional Patent Application Ser. No. 61/289,909, entitled Methods of and Systems for Improving the Operation of a Collider Chamber Apparatus, filed Dec. 23, 2009, and
U.S. Provisional Patent Application Ser. No. 61/378,582, entitled Methods of and Systems for Improving the Operation of Electric Motor Driven Equipment, filed Aug. 31, 2010.

This application is related to the following applications, the contents of which are incorporated by reference herein:
U.S. Provisional Patent Application Ser. No. 61/253,247, entitled Methods and Systems for Reduction of Utility Usage and Measurement Thereof, filed Oct. 20, 2009.

### BACKGROUND OF THE INVENTION

1. Field of the Invention

The present invention relates to methods of improving the operating characteristics of electric motor driven equipment. More specifically, the present invention relates to methods of decreasing the power consumed by an electric motor that drives various types of equipment.

2. Description of the Related Art

Examples of a collider chamber apparatus are disclosed in U.S. patent application Ser. No. 09/354,413, entitled Collider Chamber Apparatus and Method of Use of Same, filed on Jul. 15, 1999, now issued as U.S. Pat. No. 6,110,432, and U.S. patent application Ser. No. 12/061,872, entitled Collider Chamber Apparatus and Method of Use of Same, filed Apr. 3, 2008, both of which are incorporated by reference herein. As described in those applications, one embodiment of a collider chamber includes a rotor enclosed within stator, with the stator defining a plurality of collider chambers through which fluid flows. Rotation of the rotor induces cyclonic fluid flow patterns in each of the collider chambers. This fluid flow adds kinetic (and thermal) energy to the fluid contained in the collider. The fluid flow may also be conducive to promoting certain reactions and transformations within the fluid. The energy levels of molecules in the fluid, and ultimately the energy output of the collider and its ability to perform any transformations on the fluid, depend largely on the speed that the rotor rotates.

It is believed that increasing both rotor speed and the energy levels in the fluids in colliders may each be important to attaining higher output and/or efficiencies from colliders. Enabling greater collider rotor speeds by controlling drive motors with variable frequencies and voltages is one object of the invention. Increasing the energy of a fluid in a collider by applying acoustic sound waves to the fluid is another object of the invention.

### BRIEF SUMMARY OF EMBODIMENTS OF THE INVENTION

Under an aspect of the invention, a method of improving the operation of electrical motor driven equipment is disclosed.

Under another aspect of the invention, a method of operating a collider chamber apparatus includes providing a collider chamber apparatus and an alternating current electric motor. The collider chamber apparatus includes a stator including an inner wall, the inner wall defining a plurality of collider chambers, and a rotor disposed for rotation relative to the stator, about an axis. The outer wall of the rotor is proximal to the inner wall of the stator. The electric motor has at least a first wiring configuration and a second wiring configuration. The first wiring configuration is for operating at a first nameplate voltage, and the second wiring configuration is for operating at a second nameplate voltage. The first nameplate voltage is lower than the second nameplate voltage. The electric motor has a nameplate operating frequency, and the electric motor is disposed to provide a rotational driving force to the rotor of the collider chamber apparatus. The method also includes rotating the rotor relative to the stator by operating the electric motor at a voltage above the first nameplate voltage in the first wiring configuration at a frequency higher than the nameplate frequency.

Under still another aspect of the invention, a method of operating an alternating current electric motor includes providing an alternating current electric motor. The electric motor has at least a first wiring configuration and a second wiring configuration. The first wiring configuration is for operating at a first nameplate voltage, and the second wiring configuration is for operating at a second nameplate voltage. The first nameplate voltage is lower than the second nameplate voltage. The electric motor has a nameplate operating frequency. The method also includes operating the electric motor in the first wiring configuration at a selected frequency and a determined voltage. The voltage being determined based on a set of operating frequency versus operating voltage ratios over a range of operating frequencies in which a first ratio in a lower portion of the frequency range is lower than a second ratio in a middle portion of the frequency range. A third ratio in an upper portion of the frequency range is lower than the second ratio. The range of operating frequencies extends from a first frequency below the nameplate operating frequency to a second frequency above the nameplate operating frequency. The corresponding range of operating voltages extends from a first voltage below the first nameplate voltage to a second voltage above the first nameplate voltage.

Under a further aspect of the invention, the electric motor is operated at a voltage within a voltage range of about 15% above and about 15% below the second nameplate voltage. Optionally, the range can be about 10% above and about 10% below the second nameplate voltage. Optionally, the range can be about 5% above and about 5% below the second nameplate voltage.

Under yet another aspect of the invention, the set of operating frequency versus operating voltage ratios is defined by a piecewise linear function. The set of operating frequency versus operating voltage ratios can also be defined by an n-degree polynomial.

Under a further aspect of the invention, a method of reducing an amount of electrical energy consumed by electric motor driven equipment includes identifying a first electric motor used to drive equipment and operating a second electric motor in place of the first. The first electric motor has a first nameplate horsepower rating and a first number of sets of electromagnetic windings. The second electric motor has a second nameplate horsepower rating and a second number of sets of electromagnetic windings. The first nameplate horsepower rating is about twice that of the second nameplate horsepower rating, and the second number of sets of electromagnetic windings is twice that of the first number of sets of electromagnetic windings. The second electric motor also has a nameplate operating frequency, a first wiring configuration, and a second wiring configuration. The first wiring configuration is for operating at a first nameplate voltage and the second wiring configuration is for operating at a second nameplate voltage. The first nameplate voltage is lower than the second nameplate voltage. The method also includes operating the second electric motor in the first wiring configuration at a frequency above the nameplate frequency and a voltage above the first nameplate voltage.

Under another aspect of the invention, a method of treating a fluid includes providing a collider chamber apparatus. The collider chamber apparatus includes a stator, including an inner wall, the inner wall defining a plurality of collider chambers and a rotor disposed for rotation relative to the stator, about an axis. An outer wall of the rotor is proximal to the inner wall of the stator. The method also includes introducing the fluid into at least one of the plurality of collider chambers, rotating the rotor relative to the stator, and applying acoustic energy to at least a portion of the fluid. Optionally, the acoustic energy can be injected into at least one of the plurality of collider chambers, an inlet manifold for introducing fluid into at least one of the plurality of collider chambers, and/or before the fluid is introduced into at least one of the plurality of collider chambers.

Under yet a further aspect of the invention, a system for treating a fluid includes a collider chamber apparatus. The collider chamber apparatus includes a stator, including an inner wall, the inner wall defining a plurality of collider chambers for receiving at least a portion of the fluid and a rotor disposed for rotation relative to the stator, about an axis. An outer wall of the rotor is proximal to the inner wall of the stator. The system also includes a source of rotational energy for rotating the rotor relative to the stator and an acoustic driver for supplying acoustic energy to at least a portion of the fluid. Optionally, the system also includes a resonance control system. The resonance control system is in electrical communication with the acoustic driver, and the resonance control system controls characteristics of the acoustic energy supplied to the fluid by the acoustic driver.

Under yet another aspect of the invention, the system includes an acoustic pickup. The acoustic pickup monitors acoustic energy present in at least a portion of the fluid. Optionally, the system includes a resonance control system. The resonance control system is in electrical communication with the acoustic driver and the acoustic pickup. The resonance control system controls characteristics of the acoustic energy supplied to the fluid by the acoustic driver based on characteristics of the acoustic energy monitored by the acoustic pickup.

Under another aspect of the invention, the system also includes a motor and a motor control system. The motor is disposed to provide rotational energy to the rotor, and the motor control system is in electrical communication with the motor and the resonance control system. The motor control system controls a rotational speed of the motor based on information from the resonance control system.

### BRIEF DESCRIPTION OF THE SEVERAL VIEWS OF THE DRAWINGS

For a fuller understanding of the nature and objects of the present invention, reference should be made to the following detailed description taken in connection with the accompanying drawings in which the same reference numerals are used to indicate the same or similar parts wherein:

FIG. 1 shows a side view of a collider chamber apparatus.

FIG. 2 shows a top sectional view of the collider chamber apparatus taken along line 2-2 of FIG. 1.

FIG. 3 shows alternative dual-voltage motor wirings.

FIG. 4 shows a graph of predicted results of motor voltage programming.

FIG. 5 shows a graph of predicted results of a modified motor voltage programming.

FIG. 6 shows a graph of predicted results of a motor over-voltage programming.

FIG. 7 shows various frequency/voltage profiles for driving a motor.

FIG. 8 shows various frequency/voltage profiles for driving a motor.

FIG. 9 shows various frequency/voltage profiles for driving a motor.

FIG. 10 shows a side view of a collider chamber augmented with an acoustic resonance system.

FIG. 11 shows a top sectional view of a collider chamber augmented with an acoustic resonance system taken along line 2-2 of FIG. 10.

FIG. 12 shows a systems-level view of a resonance system.

FIG. 13 shows a graph of measured results of a motor over-voltage programming.

FIG. 14 shows a graph of a non-linear motor over-voltage operational curve.

FIG. 15 shows a schematic wiring diagram for the installation of a replacement motor.

FIG. 16 shows a graph of a non-linear motor over-voltage operational curve.

### DETAILED DESCRIPTION OF THE EMBODIMENTS

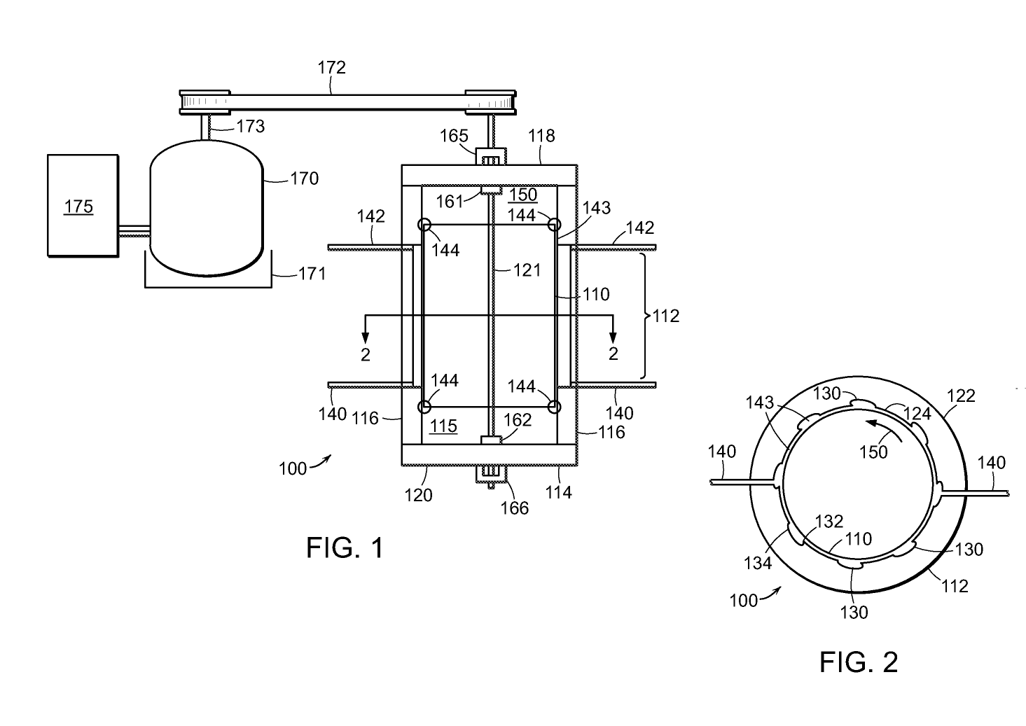

FIGS. 1 and 2 show front-sectional and top-sectional views, respectively, of a collider chamber apparatus 100. Apparatus 100 includes a rotor 110 and a stator 112. The stator 112 is formed from part of a housing 114 (shown in FIG. 1) that encloses rotor 110. Housing 114 includes a cylindrical sidewall 116, a circular top 118, and a circular bottom 120. Top 118 and bottom 120 are fixed to sidewall 116 thereby forming a chamber 115 within housing 114 that encloses rotor 110. Stator 112 is formed in a portion of sidewall 116. Rotor 110 is disposed for rotation about a central shaft 121 that is mounted within housing 114 and through circular top 118, and circular bottom 120. Shaft 121 may be continuous or provided as two halves, each mounted to opposite ends of the rotor Annular rotor seals 161 and 162 seal the interfaces, respectively, between shaft 121 and circular top 118, as well as between shaft 121 and circular bottom 120. Annular rotor seals 161 and 162 also contribute to defining, respectively, bottom chamber space 115 and top chamber space 150. Top and bottom external bearings 165 and 166 are mounted on circular top 118, and circular bottom 120 respectively, and bearings 165 and 166 support and retain shaft 121. Drive motor 170 is retained by motor housing 171, and coupled to shaft 121 via transmission 172. Transmission 172 may comprise a belt-driven or gear-driven transmission, or may comprise a direct drive from the driver motor shaft 173 to shaft 121. Transmission 172 may be selected to either increase or decrease the RPM of the rotor 110 relative to the RPM of motor 170. The drive motor shaft 173 and shaft 121 may also be co-axial. In embodiments where the drive motor 170 is an electric motor, it is supplied with power from motor driver 175. Other types of motors or drive sources may also be used for drive motor 170, both with or without a separate motor driver.

As shown in FIG. 2, the cross section of stator 112 has a generally annular shape and includes an outer wall 122 and an inner wall 124. Outer wall 122 is circular Inner wall 124 is generally circular. However, inner wall 124 defines a plurality of tear-drop shaped collider chambers 130. Each collider chamber 130 includes a leading edge 132, a trailing edge 134, and a curved section of the inner wall 124 connecting the leading and trailing edges 132, 134.

The outer diameter of rotor 110 is often selected so that it is only slightly smaller (e.g., by approximately 1/5000 of an inch) than the inner diameter of stator 112. This selection of diameters minimizes the radial distance between rotor 110 and the leading edges 132 of the collider chambers 130 and of course also minimizes the radial distance between rotor 110 and the trailing edges 134 of the collider chambers 130.

Apparatus 100 also includes fluid inlets 140 and fluid outlets 142 for allowing fluid to flow into and out of the collider chambers 130. Apparatus 100 can also include annular fluid seals 144 (shown in FIG. 1) disposed between the top and bottom of rotor 110 and the inner wall of sidewall 116. Inlet 140, outlet 142, and seals 144 cooperate to define a sealed fluid chamber 143 between rotor 110 and stator 112. More specifically, fluid chamber 143 includes the space between the outer wall of rotor 110 and the inner wall 124 (including the collider chambers 130) of stator 112. Seals 144 provide (1) for creating a fluid lubricating cushion between rotor 110 and sidewall 116, (2) for restricting fluid from expanding out of chamber 143, and (3) for providing a restrictive orifice for selectively controlling pressure and fluid flow inside fluid chamber 143. The bottom chamber space 115 between bottom 114 and rotor 110 as well as the top chamber space 150 between top 118 and rotor 110 serve as expansion chambers and provides space for a reserve supply of fluid lubricant for seals 144, 161, and 162.

Additional information on the operation of a collider apparatus may be useful in understanding other aspects and embodiments of the invention. In Newtonian physics, the kinetic energy of an object is proportional to the square of the velocity. Thus, both heat output of a collider and reactions occurring in the collider's fluid can both be highly dependent on the velocity of the particles in the collider. For example, see the cross-referenced patents and patent applications listed above and incorporated by reference herein. In turn, the velocity of the molecules in the collider is dependent on the rotational speed of the rotor, and for this reason, the speed of the rotor may greatly affect the heat output and/or efficiency of the collider. Rotor speed may also affect other performance metrics. For example, certain chemical and physical reactions may not occur without some minimum level of kinetic energy. In addition, the effective viscosity of the fluid in the collider may decrease at higher rotor speeds (possibly due to the fluid being displaced further from the rotor), which may in turn lead to better collider performance.

Colliders can present unique speed and torque requirements on drive motors. Required motor speed may be affected by the nature of the collider's construction and the collider's operational environment. In a given application, for a given desired speed, a certain amount of torque is needed to turn the rotor, and both the torque and speed requirements of the rotor may vary during the collider's operation. These variations may also depend on parameters in the fluid to be heated, treated or processed as fluid flow, as well as on the temperature, viscosity, the presence of colloids, and chemical make-up of the fluid. In some respects, it is believed that the collider may present load characteristics (and specifically, torque requirements) similar to a water-brake (such as a rotor that moves through a fluid). These load characteristics may be quite dissimilar to other AC motor applications (e.g., compressors and planers) which have substantially constant torque requirements and normally run at constant speeds.

Given the collider's dependence on rotor speed and the possible multiplicative effects on the efficiencies of applications in which colliders operate, it is believed that motor control techniques that operate motors outside of their normal operating ranges can be useful. For certain applications such as driving colliders, it is also believed that desirable application-wide efficiencies can be achieved even when the collider's drive motor is driven in operational regions in which the motor itself is not maximally efficient. For example, within a certain range of energy provided to a motor, the RPM of the motor may increase almost linearly with the amount of energy provided to the motor, but above some energy level, the returns in RPM can diminish even as the energy continues to rise. The theoretical maximum efficiency of the motor may occur somewhere around the end of the linear range of the RPM curve. However, even small increases in rotor RPM, and even increases accomplished by operating the motor above the motor's maximally-efficient RPM, may continue to yield increasing efficiencies for the overall system, at least to a point. Thus, maximum overall efficiency may entail motor torque and speed requirements that are outside of a given-sized motor's normal operational range.

To meet a collider's torque and speed requirements, the drive motor 170 in FIG. 1 may be any number of known motors such as internal combustion engines, DC motors, and AC motors. While internal combustion engines have good torque performance, they are often less “green” than electric motors, especially when many electric-production facilities are being built and operated in increasingly environmentally-efficient ways. DC motors also produce good torque, but may be less desirable from a safety perspective in facilities where water is present, such as boiler rooms. AC motors are available, but AC motors of a desirable physical size may be unable to efficiently meet the torque and/or speed requirements of a particular collider. The relationship between the motor and the remainder of a collider system are discussed in more detail next.

In one embodiment, motor 170 is a dual voltage induction-type AC motor that is “over-driven,” as described in detail below, to achieve sufficient torque to drive a collider rotor at desired speeds. The motor driver 175 is supplied with a power source, such as a 3-phase AC power source. The motor driver may be a variable-frequency drive (“VFD”), which supplies power to the AC motor. Examples of VFDs include any of several commercially-available off-the-shelf (OTS) VFDs. Many VFDs provide mechanisms to allow the VFD to receive and execute custom programming. The motor may also be driven by a constant-voltage AC source (which may be referred to as an inverter). In either of these cases, the motor driver is configured to drive the motor at an appropriate AC frequency for the desired speed.

Some background on AC induction motors is useful in further describing this embodiment. The speed of an AC motor varies with the frequency of the AC power with which it is driven. AC motors have “nameplate” (design) ratings describing a voltage and frequency at which the motor is designed to be run. For example, a motor's nameplate might designate that it is designed to be run at 230 volts at 60 Hz, and that at those values, it develops a standard nameplate horsepower and speed of 50 HP at 1800 RPM. As used herein, the nameplate values are intended as ideal or nominal values, and the actual operational value can vary above and below the nameplate value depending on a number of factors (e.g., the actual line voltage supplied at a given time). For example, a motor with a nameplate rating of 230 volts may experience a voltage of 253 volts and still be considered as operating at its nameplate rating of 230 volts. Thus, the actual operating values can vary between plus or minus 5%, 10%, and/or 15% from the nameplate value and still be considered as operating at the nameplate rating. The motor may be a dual-voltage motor, configurable to accept two different voltages, while running at the same speed. For such motors, the higher design voltage is often twice that of the lower. The motor may also be run at higher than nameplate speeds by supplying higher-than-design frequencies of AC power. However, the torque developed by the motor typically decreases when the frequency rises above its design frequency. This is due in part to the proportionally-rising impedance presented by the motor as the frequency increases. Above some frequency, as the impedance increases, the current begins to decrease because there is not enough voltage available, which results in decreasing torque. For certain sized motors used in driving colliders, this limitation can lead to a failure to achieve desired rotational speeds due to the motor's inability to drive past a certain “torque resistance barrier” and reach the desired speed. Larger motors may be available that would run the collider at the desired speeds, but these motors may not be practical to use due to considerations such as the cost and size of the motors.

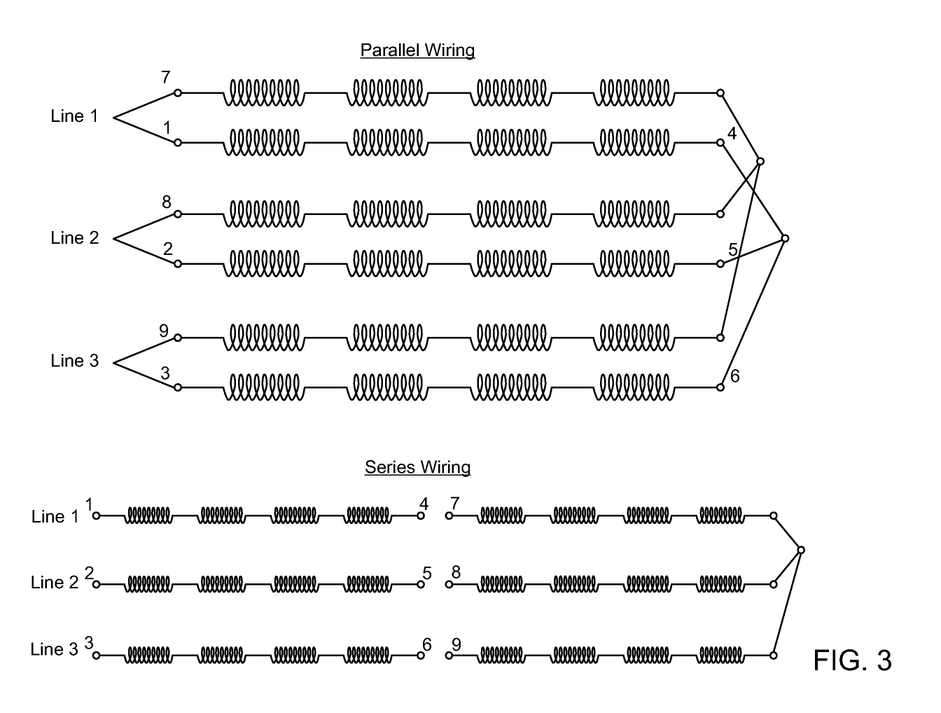

As mentioned above, in this embodiment the drive motor 170 that powers the collider's rotor is a dual-voltage AC induction motor capable of being configured to run at two separate design voltages. Such motors typically have a switch or jumper that selects whether two internal current pathways are connected to the incoming voltage source in parallel or in series. If configured for the higher of the two design voltages, the pathways are put in series so that the voltage potential in each pathway is the lower voltage. If configured for the lower voltage, that lower voltage is applied to the pathways in parallel so that in both configurations, each pathway has the same voltage (the lower voltage) across it. FIG. 3 shows parallel and series configurations for a 3 phase dual-voltage AC motor. The windings of the motor's stator have six winding circuits, each containing four coils. The top portion of FIG. 3 shows a parallel wiring configuration to support a lower voltage (e.g., 230 v), while the lower half shows a series wiring configuration to support a higher voltage (e.g., 460 v).

The dual-voltage motor is configured in this embodiment as if it were to be run at its lower design voltage, e.g., with the pathways in parallel, but is driven instead at voltages that are higher than the lower design voltage. A frequency is supplied to the motor that is higher than the design frequency for the motor, and as a result of the higher voltage and frequency, the motor operates at higher RPMs than the nameplate speed. For purposes of this description, this technique may be referred to as “over-driving” the motor. For example, a totally enclosed, fan cooled, dual voltage (230V/460V) 4-pole 100 HP motor with a nameplate speed of 1800 RPM at 60 Hz (available as Part No. 16H064W714G1 from Baldor Electric Co. of Fort Smith, Ark.) may be run at speeds near 3600 RPM by supplying the motor with 120 Hz AC power with a voltage of 460 volts using a 460V 3-phase variable frequency drive rated for 200 HP (available as Part No. HVX200A104A1N1C2 from Eaton Corp. of Cleveland, Ohio). At this voltage/frequency ratio, the motor can develop sufficient torque to run a collider at 3600 RPM. This over-driving technique can allow smaller motors to develop sufficient torque to be used to spin the collider rotor at desired speeds which are higher than the design speed and torque of the motor could otherwise accommodate.

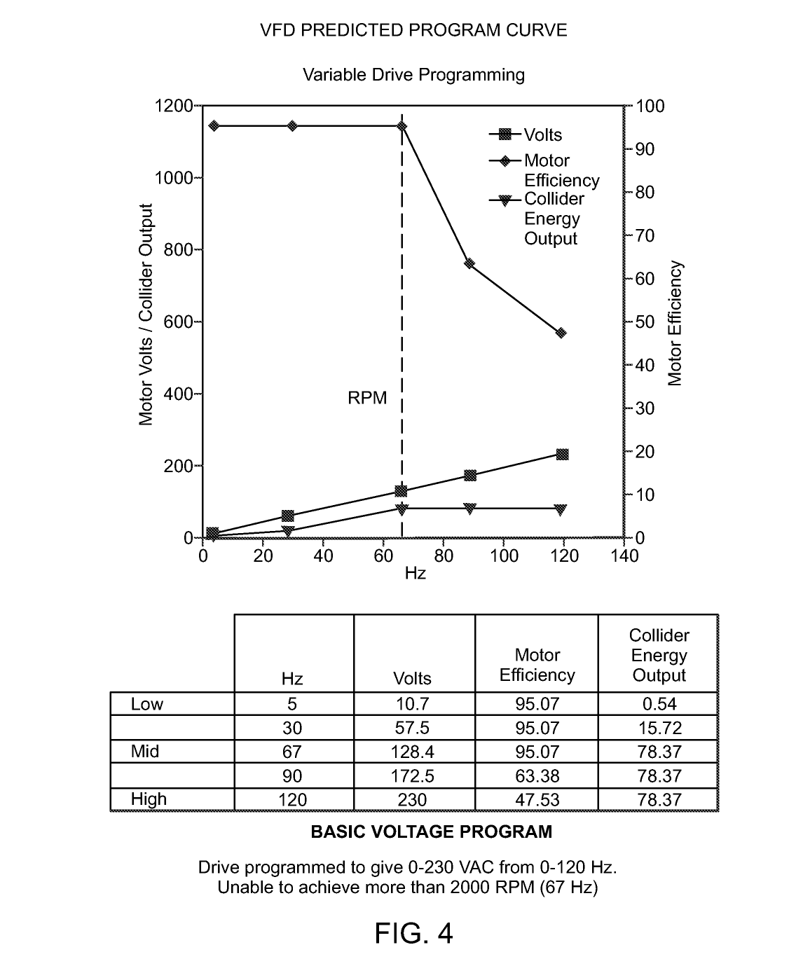

FIGS. 4-6 show performance information associated with different driving techniques for AC motors.

FIG. 4 shows predicted motor RPM, motor efficiency, and collider energy output associated with a motor driven by a VFD programmed to provide 0-230 VAC from 0-120 Hz. The “volts” curve on the graph indicates that the voltage produced by the driver increases linearly as a function of frequency from 0 to 120 Hz. The “collider energy output” curve on the graph shows that collider energy output is relatively constant from low levels of driving frequencies up to the frequency where the torque resistance barrier limits the motor RPMs. The figure also shows a torque resistance barrier (the vertical dashed line) as a frequency, and that frequency corresponds to a certain RPM that the motor cannot efficiently exceed (approximately 2000 RPM). Accordingly, despite increasing energy provided to the motor above 60 Hz, the collider's energy output remains substantially constant. The “motor efficiency” curve indicates that motor efficiency is relatively constant below the torque resistance barrier and then drops at frequencies above the barrier.

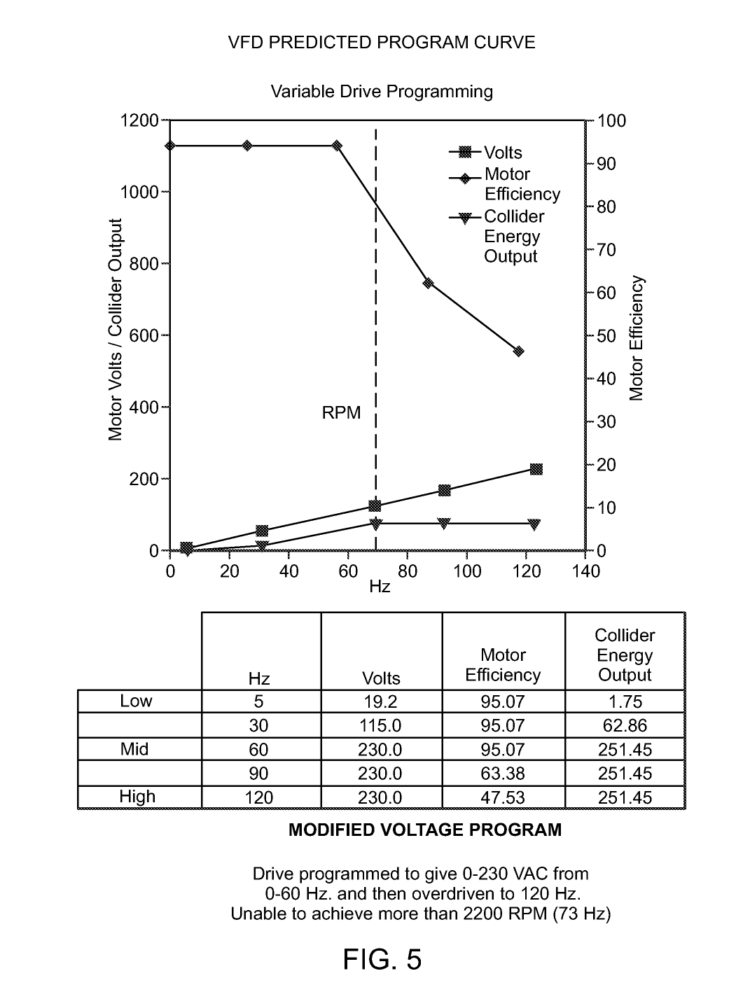

FIG. 5 shows predicted motor RPM, motor efficiency, and collider energy output associated with a motor driven by a VFD programmed to provide 0-230 VAC from 0-60 Hz, and a constant 230 v from 60 Hz to 120 Hz. The figure also exhibits a torque resistance barrier that effectively limits the speed of the motor below a certain RPM (approximately 2200 RPM).

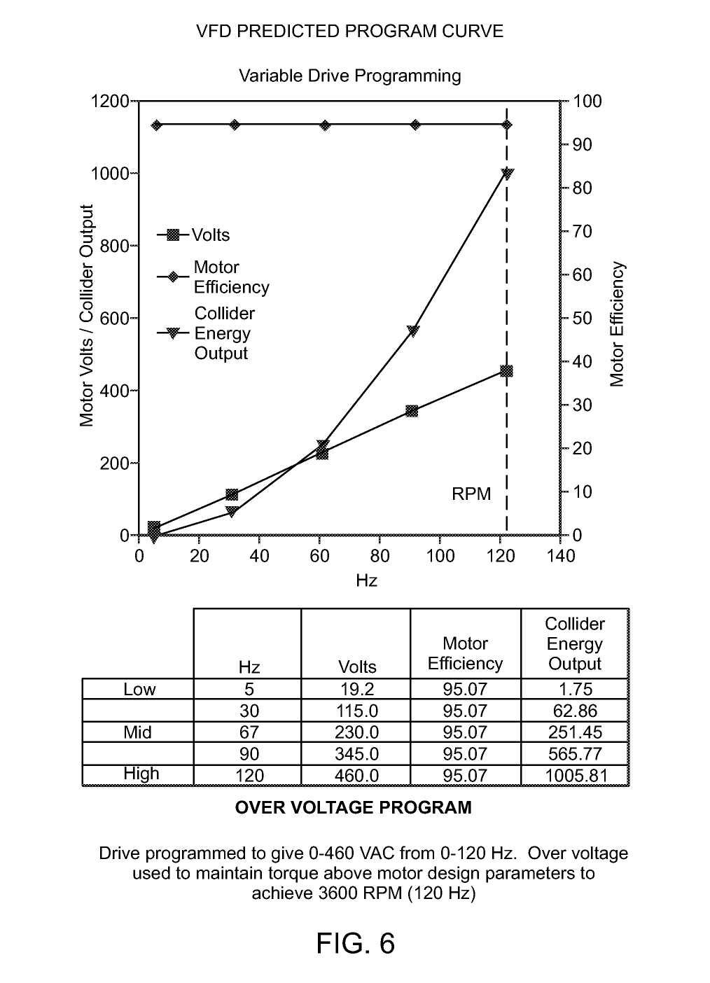

FIG. 6 shows predicted motor RPM, motor efficiency, and collider energy output associated with an over-driven motor driven by a VFD programmed to provide 0-460 VAC from 0-120 Hz where the voltage produced by the driver increases linearly as a function of frequency from 0 to 120 Hz. The figure shows that the torque resistance barrier has been overcome to achieve higher motor speeds than those shown in FIGS. 4-5, i.e., 3600 RPM. FIG. 6 also illustrates a beneficial increase in collider energy relative to FIGS. 4-5 due to greater rotor RPMs, and constant motor efficiency.

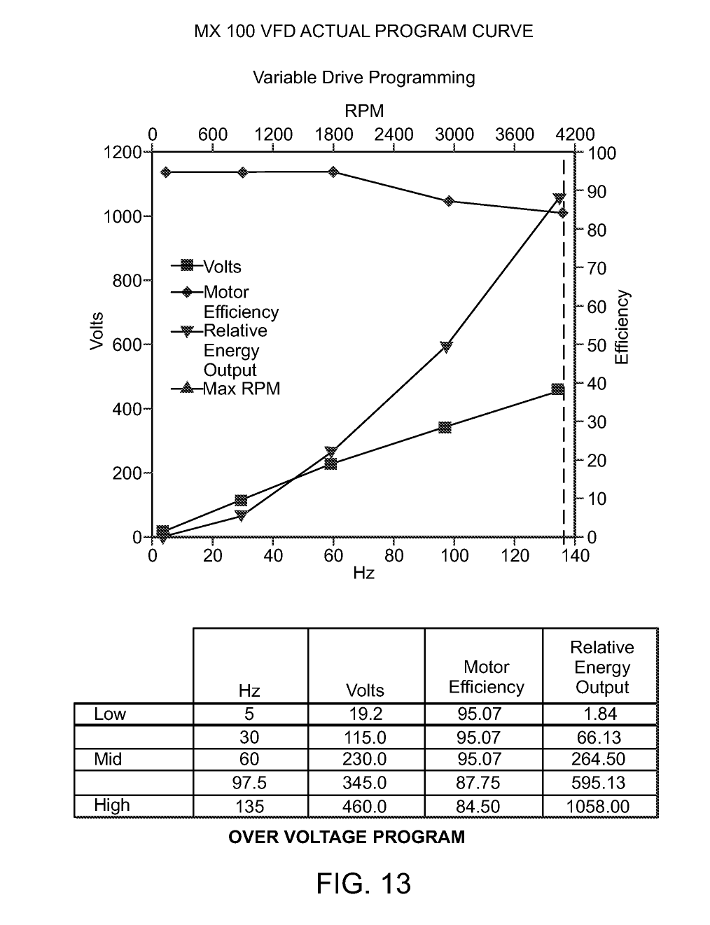

FIG. 13 shows motor RPM, motor efficiency, and collider energy output associated with an over-driven motor as measured from the operation of an installed system. The motor was driven by a VFD programmed to provide 0-460 VAC from 0-135 Hz where the voltage produced by the driver increases linearly as a function of frequency from 0 to 60 Hz and then increases at a diminishing rate from 60 to 135 Hz. The figure shows that the torque resistance barrier has been overcome to achieve higher motor speeds than those shown in FIGS. 4-5, i.e., 4,135 RPM. FIG. 13 also illustrates a beneficial increase in collider energy relative to FIGS. 4-5 due to greater rotor RPMs, and relatively constant motor efficiency.

Many dual-voltage motors are built with wiring that can safely be used with voltages higher than the lower design voltage even if the motor is configured as if it were receiving the lower design voltage. Some dual-voltage motors can even safely handle higher voltages than their rated upper voltage. Some single-voltage motors are rated such that they too can handle higher-than-nameplate voltages.

In still another embodiment, motor driver 175 drives a drive motor 170 that is a single-voltage motor that has an internal design and wiring capable of safely withstanding a higher-than-nameplate input voltage.

In still another embodiment, drive motor 170 is an AC motor that is over-driven to achieve higher speeds even if the motor operates at a lower efficiency (with respect to the input power and the output torque and speed) than it could operate at if it were not over-driven.

AC motors are typically designed to accept varying frequencies and voltage levels such that the voltage/frequency ratio remains substantially constant. For example, a 230 V, 60 Hz, 1800 RPM motor can instead be run at 900 RPM by supplying 30 Hz, but the motor is designed to receive only 115 V at that frequency, thus maintaining the constant ratio.

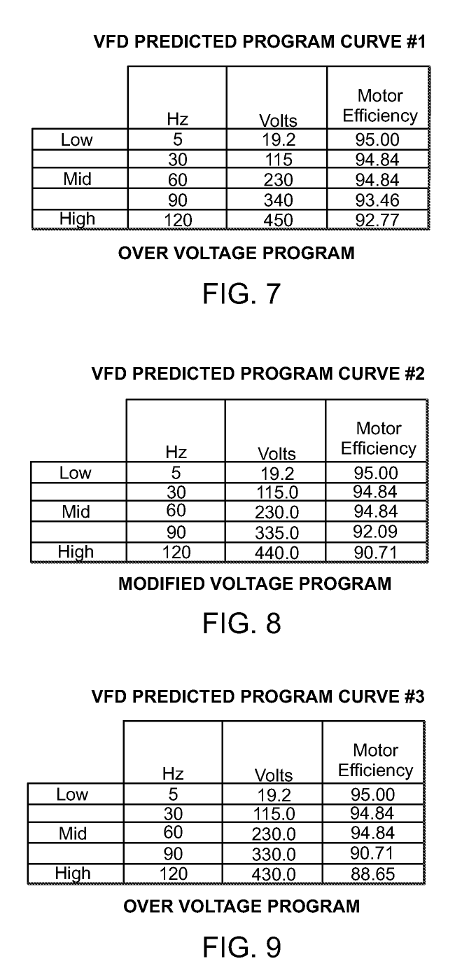

In yet another embodiment, an AC motor driving a collider may be driven with voltage/frequency combinations whose ratio varies as the frequency changes. FIGS. 7-9 show several possible frequency/voltage curves or “profiles,” each of which present one possible set of voltage/frequency combinations that may be applied to a motor as an example of this embodiment. In FIGS. 7-9, at supply frequencies above the motor's design frequency, the motor driver 175 is programmed to supply voltage and frequencies that vary non-linearly as the frequency is increased, where the voltage increases at a diminishing rate. In this embodiment, motor driver 175 drives motor 170 based on voltage and frequency combinations chosen from the profiles in FIGS. 7-9.

For a given desired speed of the rotor, a corresponding frequency and voltage at which to drive the motor are determined and applied to the motor. This may be done in several ways, including by using a fixed inverter as a motor driver 175, where the inverter is configured to produce a suitable voltage and frequency for the desired speed.

In still another embodiment, motor driver 175 is an OTS VFD, and the VFD is programmed with a custom frequency/voltage profile. The profile may be specified as a piecewise linear function, a parameterized curve using two or more points to specify a n-degree polynomial, as a fixed set of frequency and voltage value pairs, or other methods known in the art. These profiles may be based on the profiles disclosed in FIGS. 7-9. The VFD is then is commanded to drive the motor at a particular speed. In response, the VFD uses the pre-programmed profile to send a selected frequency and a corresponding voltage to drive motor 170.

In still another embodiment, the information to describe the frequency/voltage profile for a VFD motor driver 175 are empirically derived. For example, the performance of a collider at different desired speeds (and/or at corresponding drive frequencies) can be measured at varying frequencies and voltages to determine a set of desirable frequency and voltage value pairs for operating the collider efficiently. From that data, a profile may be developed using one of several known techniques such as linear regression or other curve-fitting methods.

In yet another embodiment, several frequency/voltage profiles may be derived for a VFD motor driver 175, each suited to particular collider load scenarios, including particular sets of flow, temperature, fluid dynamics and desired performance of the collider. During operation, one of the several profiles is selected for use to drive the motor depending on operating conditions.

When over-driving motors using these methods, certain design considerations may need to be made to accommodate the resulting power-levels and speeds of the motor. Larger bearings may be necessary to safely support the moving parts than those that might be required for motors that are running at lower speeds. The bearings may placed externally to the circular top 118 and a circular bottom 120 in order to reduce their operating temperatures. Larger-capacity inverters or VFDs may be necessary. Additional and/or more efficient cooling may also be necessary for the collider and/or the drive motor 170. Larger or stronger connections between the motor and the rotor may be warranted, possibly including the use of geared transmissions or belts for transmission 172.

The construction of the rotor may also be affected. It may be advantageous to provide a coating to outside of the rotor. Specifically, the coating could be a ceramic coating or an anodized layer, such as an aluminum oxide coating. Such coatings may be selected so as to increase the usable life of the rotor and/or to increase the performance of the collider. Coatings may be selected to increase or decrease the capillary action of the rotor. Coatings could also include substances that act as catalysts. Coatings may also include ribbed and/or scoriated treatments to the rotor surface.

Depending on the desired rotational speed of the motor and the selection of fluids in the collider, the rotor may also be outfitted with fan-like blades, including blades to cause compression of the fluids. The collider may also be used with non-liquids, including gases.

In addition to increasing the energy in a collider by increasing the rotational speed of the rotor, energy may also be added to the fluid in the collider by applying acoustic sound waves directly to the fluid or indirectly through elements that are in contact with the fluid. This acoustic energy may cause cavitation in the fluid, which can create heat as at least one by-product. The embodiments described below may be used alone or in conjunction with the variable-frequency motor drive techniques described in the preceding paragraphs.

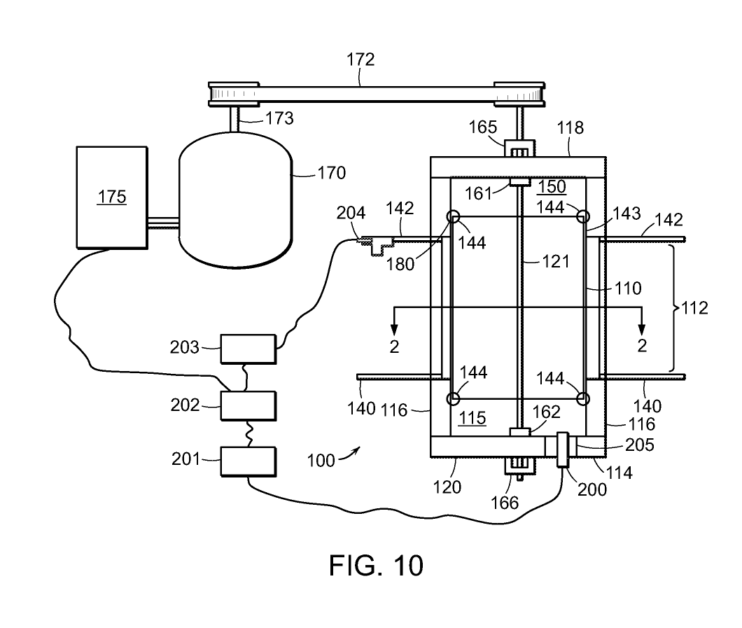

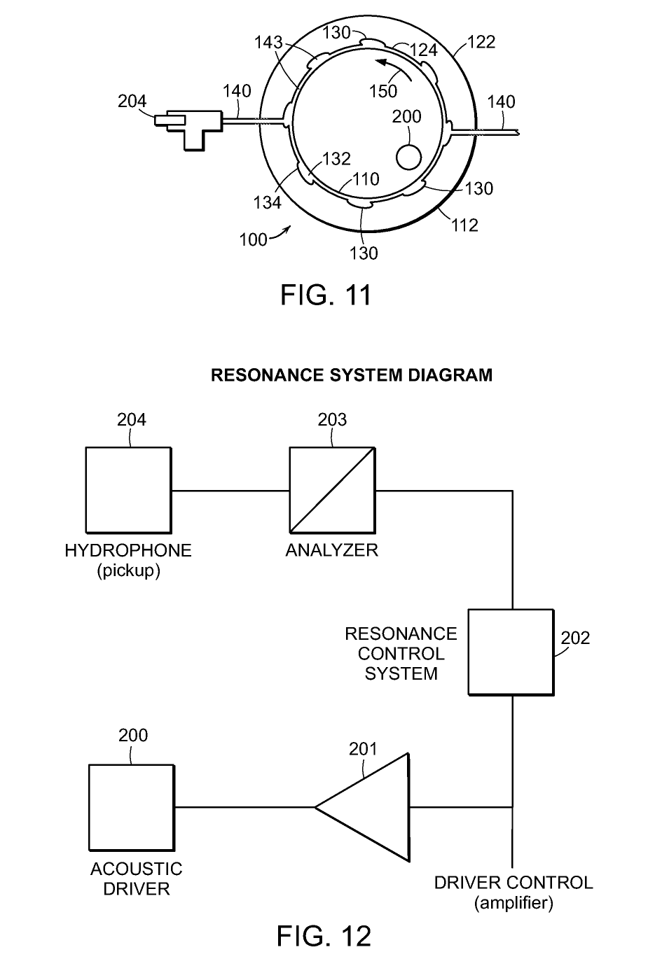

FIGS. 10 and 11 show an embodiment of a collider apparatus 100 fitted with an acoustic driver 200, driver control 201, pickup 204, frequency analyzer 203, and resonance control system 202. The driver control 201 controls and provides energy to the acoustic driver 200. The frequency analyzer 203 receives frequency information from pickup 204 and may send that information to resonance control system 202. In certain embodiments, only a portion of the devices shown in FIG. 4 are used, as described in more detail below.

Referring now to FIG. 10, a driver inlet is provided in the collider apparatus 100 through bottom 120. An acoustic driver 200 is situated within the driver inlet through the bottom 120 using one or more annular fluid seals 205 so that the driver contacts the fluid in chamber 115. The annular fluid seals 205 may be a hi-temperature flexible seal Annular seals may also be used around the pickup 204. The acoustic driver 200 (and associated inlet and seals) may alternatively be situated elsewhere on the chamber, including on the top 118, or on the wall 116 adjacent to either space 115 or 150. The acoustic driver 200 is preferably selected and situated so that it can inject sound energy into the fluid in the collider at energy levels of at least 10 decibels in frequency ranges of normally between 10 Hz and 100,000 Hz. The operating frequency or frequencies of the driver may depend on factors such as the sound speed and chemical characteristics of the fluid within the chambers, the number of chambers used, the chamber's geometry and the characteristics of the drivers themselves. If the driver 200 is situated adjacent to bottom chamber 115 or top chamber 150, seals 144 are preferably selected so that the sound injected into 115 or 150 is transmitted with sufficient energy into sealed fluid chamber 143 between rotor 110 and stator 112. The sound waves will also react through the top and bottom fluid chambers 115 and 150 onto the rotor 110 itself thereby transmitting acoustic energy to all of the collider chambers 130 at once.

In still another embodiment, the acoustic driver 200 (and associated inlet and seals) may be located in an fluid inlet/outlet raceway 180, which acts as a manifold, so that the driver is in more direct contact with the liquid in sealed fluid chamber 143. Further, one or more acoustic drivers 200 may be disposed to inject sound energy directly into a corresponding one or more collider chambers 130.

In yet another alternative embodiment, the acoustic driver 200 may be located inside of one of the inlet pipe 142 or outlet pipe 140. In this embodiment, the acoustic driver is sized and placed within the pipe so as not to disrupt the flow of liquid more than necessary.

The driver is controlled to inject energy into the fluid at one particular frequency, several frequencies, or direct energy in a continuous or discrete set of frequencies defined within a certain spectrum. The frequency or frequencies are preferably selected to achieve the goals of increasing the heat output or efficiency of a collider and/or to promoting or controlling certain reactions occurring in the collider's fluid. The acoustic driver may amplify existing and/or naturally-occurring resonant frequencies in the collider chamber, add new frequencies, or act to effectively cancel or reduce the amplitude of undesired frequencies.

FIG. 12 shows a system-level view of the resonance system including acoustic driver 200, driver control 201, resonance control system 202, frequency analyzer 203, and pickup 204. Acoustic driver can be, for example, any number of transducer products for use in liquids (available from ITC of Santa Barbara, Calif.). Frequency analyzer 203 can be, for example, a Quattro DSPcentric Signal Processing Analyzer and SignalCalc ACE Dynamic Signal Analysis Software (available as Part Nos. DP240H-4C1S and DP240-10, respectively, from Data Physics Corp. of San Jose, Calif.). Pickup 204 can be, for example, a hydrophone with pre-amp modified for up to 45 kHz frequency range (available as Part No. HTI96MINHEX from High Tech, Inc. of Gulfport, Miss.). Pickup 204 is connected so as to provide information on detected sound energy to frequency analyzer 203, which in turn is connected so as to provides frequency information to resonance control system 202. Resonance control system 202 controls driver controller 201, which in turn drives acoustic driver 200. Driver controller 201 is preferably selected to provide the acoustic driver 200 with sufficient energy at appropriate frequencies to achieve the desired goals listed above. The controller may be a fixed frequency source, or a programmable frequency source, including programmable frequency sources that are programmable in real time.

In still another alternative embodiment, additional acoustic drivers are installed on the collider, which are either operated by control system 202 and driver 201, or by one or more additional control systems. The drivers may be positioned at acoustic pressure antinodes or other areas selected so as to maximize the energy transfer to the fluid.

In yet another alternative embodiment, a pump may be interposed at a point along the inlet pipe to change the pressure of the fluid and/or gases in the collider. Different pressures may result in cavitating bubbles and higher heat output.

In still another alternative embodiment, driver controller 201 and/or resonance control system 202 varies the frequencies of acoustic driver 200 based on at least one of fluid flow, temperature, and viscosity in the collider.

Referring again to FIG. 10, in yet another alternative embodiment, acoustic driver 200 is controlled by resonance control system 202 in a closed-loop fashion using, in part, feedback from the pickup device 204. An acoustic pickup device 204 may be situated inside of outlet 142 so that the pickup is in contact with the fluid in the collider. The pickup device 204 may alternatively be situated elsewhere on the chamber, including on the wall 116, circular top 118 or bottom 120, or another location where the pickup is capable of receiving and transmitting information on the acoustic frequencies present in the collider. The pickup device 204 is preferably selected to receive acoustic energy in approximately the expected range of frequencies occurring within the collider. This range may include both natural resonant frequencies of the collider as well as frequencies injected into the collider by acoustic driver 200. The acoustic pickup 204 is connected to frequency analyzer 203, which converts the sound information to computer-readable values of power versus frequency. Frequency analyzer 203 is connected to resonance control system 202. Resonance control system 202 processes the information from the pickup, calculates control information and then sends the control information to the acoustic driver controller 201. The resonance control system 202 may be a PC, an embedded controller, or other computing system. Control information may be calculated by the resonance control system 202 using spectral information from the frequency analyzer 203, and possibly combined with other control and measurement information from an operator and/or from measurement points throughout the larger overall system in which the collider is operating.

In another embodiment, resonance controller 202 operates so that it detects one or more main frequencies (or subharmonics thereof) components and controls the acoustic driver controller 201 to cause the acoustic driver to inject additional sympathetic acoustic energy into the collider to diminish or reinforce one or more of the measured frequencies or to create new frequencies.

In another embodiment, resonance controller 202 operates to control and/or monitor the operation of motor driver 175.

In still another embodiment, the frequency analyzer 203 is not separate from the resonance controller 202, and the controller 202 analyzes the output of the acoustic pickup 204 itself. This analysis can take the form of a Fast-Fourier-Transformation or other well known time-to-frequency domain transformations.

The techniques set forth in detail above can also be applied in such a way as to increase the efficiency of the operation of motor-driven equipment. Specifically, a lower horsepower motor that has a greater number of “poles” replaces an existing motor, and the new motor is operated in an overspeed condition. As used herein, the number of “poles” of a motor are the number of sets of three-way electromagnetic windings of the motor. Thus, using the techniques set forth herein, a second motor can be operated in place of a first motor. The nameplate horsepower of the second motor can be about half, or lower, than that of the nameplate horsepower of the first motor. Meanwhile, the number of poles of the second motor are at least double that of the first motor. For example, an 8-pole motor with a nameplate of 50 HP and a speed of 900 RPM at 60 Hz replaces a 4-pole motor with a nameplate of 100 HP and 1800 RPM at 60 Hz. The 50 HP motor is run at speeds near 1800 RPM by supplying the motor with 120 Hz AC power at 460 volts. As described above, although the motor is supplied with 460 volts, the motor is wired as if it were to be supplied with 230 volts. Because an 8-pole motor develops approximately twice the amount of torque per horsepower as a 4-pole motor (6 ft-lbs as opposed to 3 ft-lbs), it is thought that the motor will not be torque-limited in this application.

Because the 50 HP motor is expected to use about 50% or less of the amount of energy that would be consumed by the 100 HP motor in the same service, an energy savings of about 50% or more is thought to result. Furthermore, because the use of a higher operating voltage allows for a reduction in operating current, in certain types of service, it is thought that additional energy savings can be realized because of a reduction in the waste heat generated by the electric motors driving the equipment. To illustrate this aspect, assume the motor replacement described above was done in an air conditioning system, and further assume the motor was physically situated within the space being cooled by the air conditioning system. Because of the reduction in power consumption, it is expected that the amount of waste heat produced by the 50 HP motor is also reduced. Thus, because a lower amount of waste heat is entering the space being cooled, less cooling is required to achieve the desired environmental conditions.

In order to enable the replacement motor to operate in place of the first motor, additional modifications to the motor may be required relative to a “standard” or “off-the-shelf” motor. In one implementation, increased cooling may be provided over what would typically be recommended for a motor having the given nameplate ratings. This can take the form of an increased fan size or other technique for providing an increased amount of cooling air to the motor than would traditionally be supplied. In another implementation, the bearings used in the second motor, e.g., along the rotor shaft, may be modified to accommodate the higher maximum operating rotational speed and/or higher maximum operating torque achieved in the methods of operation described herein. For example, bearings based on ball bearings or roller bearings are replaced with bearings based on spherical or elliptical roller bearings (i.e., the rollers are slightly crowned or end relieved). A high temperature grease may also be required. Furthermore, the rotor of the replacement motor may also be balanced for operation at the relatively higher rotational speeds and/or higher torque applications, e.g., 1800 RPM or higher versus 900 RPM.

Additional motor modifications include changes to the motor insulation rating and the motor winding density. For example, a motor may need to be upgraded to a higher temperature tolerance class based on the maximum operating frequency at the maximum operating torque. For example, a standard National Electrical Manufacturers Associate (NEMA) Temperature Tolerance Class A or Class B insulation system may be upgraded to a NEMA Class F or Class H system. Furthermore, the density of the motor windings can be increased to provide an increased level of breakdown torque when operating at higher than nameplate frequencies. Thicker winding wire and/or additional winding “turns” can be added to the rotor teeth in order to provide a desired breakdown torque defined in terms of the nameplate horsepower of the motor. For example, an 8-pole 50 HP motor is expected to have a 300 ft-lbs torque rating. Thus, a breakdown torque value for such a motor can be designated as 150% of this value, or 450 ft-lbs, at the maximum operating frequency (e.g., 120 Hz). However, other breakdown torque values can be designated, for example, 200%, 175%, 125%, and 100% of the rated torque (based on the nameplate horsepower rating) are within the scope of the invention. Moreover, modifications can be made to the stator windings, alone or in combination with changes to the rotor windings, to achieve the desired Breakdown Torque value.

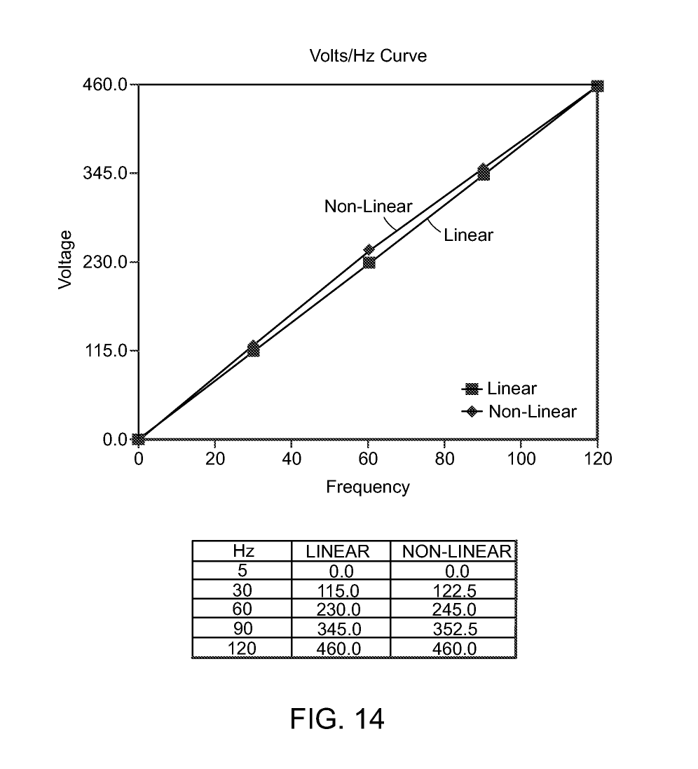

In accordance with the systems, methods, and operational techniques disclosed above, the voltage program for operating the 50 HP motor can be non-linear, as shown in FIG. 14. The non-linear nature of the curve is thought to assist in overcoming potential torque barriers during motor run-up as well as reduce the inductive reactance encountered when varying the speed of the motor in the middle region of the frequency curve. In other words, it is thought that by having voltage above a 1:1 scaled ratio (voltage range to frequency range), additional torque is available to increase the speed of the motor by commanding a higher operating frequency. Thus, implementations of the invention permit more torque to be available at lower HP relative to operation with a linear curve of voltage to frequency. In other words, rather than operating with a constant torque output across the frequency range, systems employing the non-linear curve employ a variable torque curve. Although FIG. 14 shows a maximum frequency of 120 Hz, the non-linear curve can be scaled to operate with a maximum frequency above or below 120 Hz.

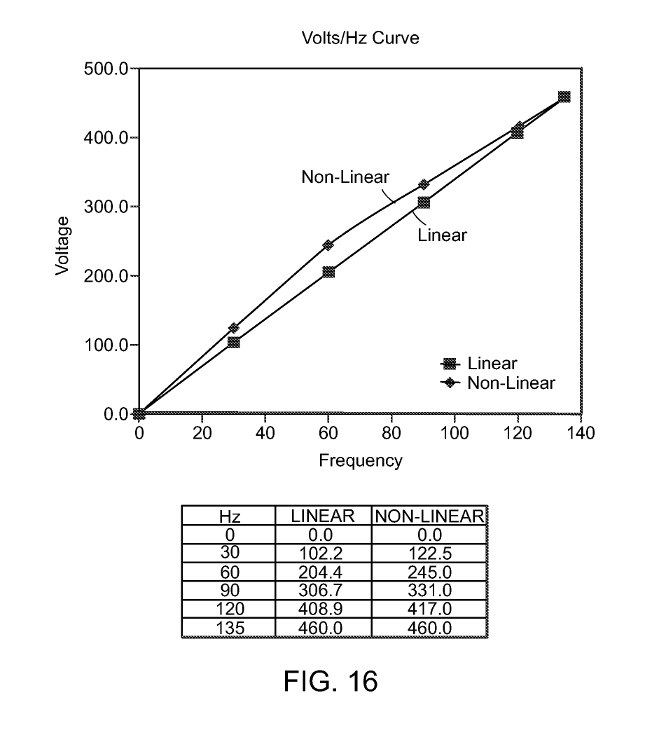

For example, FIG. 16 shows a curve wherein the voltage varies non-linearly between 0-460 V as the frequency varies between 0-135 Hz. This curve has been used to drive an embodiment of a collider chamber apparatus as described herein. This particular curve shows a more pronounced non-linearity (or voltage “hump”) in the middle region of the frequency range. Several examples of non-linear voltage/frequency curves are disclosed herein. However, it is understood that other curves, having varying degrees of non-linearity, are within the scope of the invention. In any case, the non-linear curve will exhibit a voltage hump in the middle region of the frequency range as compared to a linear curve spanning the same voltage and frequency range.

Furthermore, under an additional aspect of the invention, a non-linear voltage/frequency curve is designed according to the particular properties of the operation and/or process in which the motor will be employed. For example, a linear curve can be used to operate an electric motor in a particular process. During normal operation, with the linear curve, the amount of current consumed by the motor is monitored throughout its operational range. If current peaks are encountered in a particular frequency region, the voltage to frequency ratio around that region can be increased to make additional torque available when speed changes are commanded with that region. In this way, a custom non-linear voltage/frequency curve can be created to fit the particular needs of a given operation and/or process.

A 100 HP motor used in the system shown in FIG. 1 and employing a non-linear frequency/voltage curve, as described above in connection with FIG. 16, has demonstrated energy usage reductions of approximately 30% when operating above 60 Hz. Similar savings are expected when using the techniques set forth herein in systems not employing a collider chamber apparatus. In other words, the use of a lower horsepower motor that has a greater number of poles, which is operated in an overspeed condition, to replace an existing motor is not limited to air conditioning systems, but rather, can be applied to a wide variety of motor-driven equipment. For example, the techniques disclosed herein can be applied to electric motors used to drive pumps, fans, blowers, industrial conveyors, escalators, elevators, and/or compressors. Furthermore, it is proposed that applications currently employing the use of DC electric motors can be accomplished by replacing the DC motor with an inverter and AC motor. Thus, the techniques herein are thought to be applicable for use in electric motor driven vehicles, e.g., hybrid cars, trains, haul trucks, and/or other diesel/electric drive train powered systems.

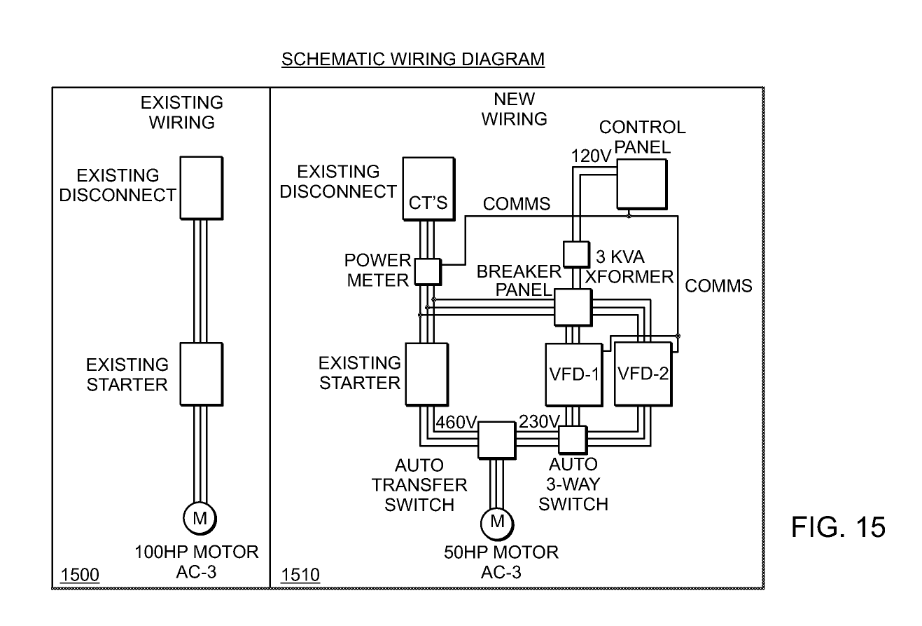

FIG. 15 illustrates a schematic wiring diagram for the replacement of an existing 100 HP 4-pole motor with a new 50 HP 8-pole motor to be operated in an overspeed condition. The existing wiring 1500 directly connects the existing 100 HP motor to the power feed via the existing starter. The new wiring 1510 interposes an auto transfer switch between the existing starter and newly installed VFD-1 and VFD-2. The existing starter is wired to the motor as 460 V. In contrast, the VFDs are wired to the motor as 230 V, despite the fact that up to 460V will, in fact, be supplied. Although two VFDs are shown, only a single VFD is needed for operation of the system. The VFD-2 can be available for backup operation, or can be configured with a particular frequency/voltage curve while VFD-1 is operating the motor and vice-versa. The two VFDs are connected to the new 50 HP motor via an auto 3-way switch. The VFDs are powered by the existing power feed by way of a breaker panel. A step-down transformer is also included to provide power to a system control panel. The control panel communicates with a power meter and the two VFDs. The control panel also contains a control system for monitoring power consumption via the power meter and for controlling the operation of the 50 HP motor via the two VFDs.

In a further embodiment of the invention, one or both VFDs are replaced with a regenerative motor drive, which is capable of converting the kinetic energy of the rotating equipment into electrical energy during the spin-down or braking of the rotating equipment. This electrical energy is then fed into the electrical supply system to reduce the overall electrical energy consumed by the facility in which the motor system is installed. Thus, this additional embodiment further increases the overall operational efficiency of the motor installation.

In another implementation of the invention, an existing motor that is being driven by an existing VFD is replaced with a new motor having a lower horsepower and greater number of poles relative to the existing motor, as described above. In such an implementation, the operation of the existing equipment (including the existing motor) is analyzed over its operational range. A custom voltage/frequency curve is then generated, according to the techniques set forth above, to apply the most advantageous torque profile for the given operation and/or process. The existing VFD is then reprogrammed to use the custom non-linear voltage/frequency curve with the new motor. As mentioned above, a 100 HP motor used in the system shown in FIG. 1 and employing a non-linear frequency/voltage curve, as described above in connection with FIG. 16, demonstrated energy usage reductions of approximately 30% when operating above 60 Hz. By replacing the 100 HP motor with a new motor having a lower horsepower and greater number of poles (e.g., from 100 HP to 50 HP, and from 2-poles to 8-poles, respectively), it is thought that an additional savings of about 30% will be realized over and above the original savings. Thus, the replacement motor and, optionally, a VFD operated in accordance with the techniques described herein function as an alternative source of energy in that electric energy that would otherwise need to be generated is conserved. Furthermore, operating an existing motor in accordance with the techniques set forth herein alone acts as an alternative source of energy in the same manner.

U.S. Provisional Patent Application Ser. No. 61/253,247, entitled Methods and Systems for Reduction of Utility Usage and Measurement Thereof, incorporated above, discloses techniques for quantifying the utility savings attributable to an energy conservation measure and/or energy efficiency measure. In one embodiment, a baseline utility usage is measured periodically during normal operation of the utility consuming equipment by essentially bypassing the energy conservation and/or efficiency measure for a short period of time relative to the overall duration of the operation of the utility consuming system. Implementations of the invention disclosed in U.S. Provisional Patent Application Ser. No. 61/253,247 can be used with the techniques disclosed herein for measuring the reduction of electrical energy consumed by electrical motors. However, because the techniques herein describe replacing a higher HP motor with a lower HP motor, an adjustment factor must be applied during the baseline operation period.

For example, the new wiring 1510 shown in FIG. 15 enables the existing starter to drive the new 50 HP motor during short periods of time to establish a baseline energy consumption. However, because the original equipment was a 100 HP motor, the amount of electrical energy consumed by the 50 HP motor during operation using the existing starter must be multiplied by a correction factor (e.g., doubled) in order to estimate how much electrical energy would have been consumed by the 100 HP motor. During the remaining operational periods, the new 50 HP motor is driven with the new VFD equipment. As described in the incorporated application, the baseline consumption can be established as needed to determine the actual electrical energy reduction provided by the new equipment operation. The measurement of energy consumption, control of which equipment is driving the motor, and the determination of the reduction in utility consumption is performed using the power meter, auto transfer switch, auto 3-way switch, and control equipment in the control panel.

The techniques for increasing the efficiency of a collider chamber apparatus and/or reducing the energy consumed by an electric motor, as disclosed herein, can be used in conjunction with techniques for a “shared energy/savings” system in which a first party engineers, installs, owns, and operates an energy conservation measure and/or energy efficiency measure (e.g., a Molecular Accelerator™ MX-100 product and/or any electrical motor driven equipment) in a facility of a second party with no capital contribution from the said second party. Payments by the second party to the first party will be based upon a share of the net energy and operational savings and the related greenhouse gas emission credits due to the energy conservation and/or efficiency measure over an agreed to lease term. At least a portion of these payments then fund the installation of additional energy conservation and/or efficiency measures. Any of the techniques and systems described herein can be employed as the energy conservation and/or efficiency measure that is responsible for generating the energy savings. For example, any electrical energy saved due to the installation described in connection with FIG. 15 will result in lower electrical bills for the facility owner (the “second party”). This savings can be shared with the installer/operator (“first party”) as a means for funding the installation of additional equipment.

Furthermore, one of many collider chamber apparatus applications or other electric motor application is in augmenting climate control systems of commercial buildings to help increase their efficiencies or to provide other beneficial modifications to the systems' operations. The systems in these facilities are often complex and highly dynamic, exhibiting frequent variations in temperature, fluid flow, and system load. The efficiency and overall environmental impact of the operation of these systems is important due to concerns about cost and regulatory compliance, as well as the increasing focus on “green” (environmentally sustainable) buildings. In these applications, the efficiency of the overall system may depend significantly on the efficiency and output of the collider, and in certain situations, the collider's operation may have a multiplicative effect on the output and/or efficiency of downstream elements of the larger system. The same is true for any other electric motor driven equipment operated in accordance with the techniques set forth herein.

Since certain changes may be made in the above apparatus without departing from the scope of the invention herein described, it is intended that all matter contained in the above description or shown in the accompanying drawings shall be interpreted in an illustrative and not a limiting sense.

What is claimed is:

1. A method of operating a collider chamber apparatus, the method comprising:
providing a collider chamber apparatus, the collider chamber apparatus comprising:
a stator including an inner wall, the inner wall defining a plurality of collider chambers; and
a rotor disposed for rotation relative to the stator, about an axis, an outer wall of the rotor being proximal to the inner wall of the stator;
providing an alternating current electric motor, the electric motor having at least a first wiring configuration and a second wiring configuration, the first wiring configuration for operating at a first nameplate voltage and the second wiring configuration for operating at a second nameplate voltage, the first nameplate voltage being lower than the second nameplate voltage, the electric motor having a nameplate operating frequency, and the electric motor disposed to provide a rotational driving force to the rotor of the collider chamber apparatus; and
rotating the rotor relative to the stator by operating the electric motor at a voltage above the first nameplate voltage in the first wiring configuration at a frequency higher than the nameplate frequency.

2. The method of claim 1, the operating the electric motor at the voltage above the first nameplate voltage comprising operating the electric motor at a voltage within a voltage range of about 15% above and about 15% below the second nameplate voltage.

3. The method of claim 2, the operating the electric motor at the voltage above the first nameplate voltage comprising operating the electric motor at a voltage within a voltage range of about 10% above and about 10% below the second nameplate voltage.

4. The method of claim 3, the operating the electric motor at the voltage above the first nameplate voltage comprising operating the electric motor at a voltage within a voltage range of about 5% above and about 5% below the second nameplate voltage.

5. The method of claim 1, the operating the electric motor at the voltage above the first nameplate voltage comprising operating the electric motor at a selected frequency and a determined voltage, the voltage being determined based on a set of operating frequency versus operating voltage ratios over a range of operating frequencies in which a first ratio in a lower portion of the frequency range is lower than a second ratio in a middle portion of the frequency range, and a third ratio in an upper portion of the frequency range is lower than the second ratio, the range of operating frequencies extending from a first frequency below the nameplate operating frequency to a second frequency above the nameplate operating frequency, and the corresponding range of operating voltages extending from a first voltage below the first nameplate voltage to a second voltage above the first nameplate voltage.

6. The method of claim 5, the set of operating frequency versus operating voltage ratios being defined by a piecewise linear function.

7. The method of claim 5, the set of operating frequency versus operating voltage ratios being defined by an n-degree polynomial.

8. The method of claim 5, the set of operating frequency versus operating voltage ratios being defined at least in part by the ratios 0 Hz to 0 volts, 30 Hz to 122.5 volts, 60 Hz to 245 volts, 90 Hz to 352.5 volts, 120 Hz to 460 volts, and a linear interpolation of operating frequencies and operating voltages there between.

9. The method of claim 5, the set of operating frequency versus operating voltage ratios being defined at least in part by the ratios 0 Hz to 0 volts, 30 Hz to 122.5 volts, 60 Hz to 245 volts, 90 Hz to 331 volts, 120 Hz to 417 volts, 135 Hz to 460 volts, and a linear interpolation of operating frequencies and operating voltages therebetween.

10. A method of operating an alternating current electric motor, the method comprising:
providing an alternating current electric motor, the electric motor having at least a first wiring configuration and a second wiring configuration, the first wiring configuration for operating at a first nameplate voltage and the second wiring configuration for operating at a second nameplate voltage, the first nameplate voltage being lower than the second nameplate voltage, and the electric motor having a nameplate operating frequency; and
operating the electric motor in the first wiring configuration at a selected frequency and a determined voltage, the voltage being determined based on a set of operating frequency versus operating voltage ratios over a range of operating frequencies in which a first ratio in a lower portion of the frequency range is lower than a second ratio in a middle portion of the frequency range, and a third ratio in an upper portion of the frequency range is lower than the second ratio, the range of operating frequencies extending from a first frequency below the nameplate operating frequency to a second frequency above the nameplate operating frequency, and the corresponding range of operating voltages extending from a first voltage below the first nameplate voltage to a second voltage above the first nameplate voltage.

11. The method of claim 10, the operating the electric motor comprising operating the electric motor at a voltage within a voltage range of about 15% above and about 15% below the second nameplate voltage.

12. The method of claim 11, the operating the electric motor comprising operating the electric motor at a voltage within a voltage range of about 10% above and about 10% below the second nameplate voltage.

13. The method of claim 12, the operating the electric motor comprising operating the electric motor at a voltage within a voltage range of about 5% above and about 5% below the second nameplate voltage.

14. The method of claim 10, the set of operating frequency versus operating voltage ratios being defined by a piecewise linear function.

15. The method of claim 10, the set of operating frequency versus operating voltage ratios being defined by an n-degree polynomial.

16. The method of claim 10, the set of operating frequency versus operating voltage ratios being defined at least in part by the ratios 0 Hz to 0 volts, 30 Hz to 122.5 volts, 60 Hz to 245 volts, 90 Hz to 352.5 volts, 120 Hz to 460 volts, and a linear interpolation of operating frequencies and operating voltages therebetween.

17. The method of claim 10, the set of operating frequency versus operating voltage ratios being defined at least in part by the ratios 0 Hz to 0 volts, 30 Hz to 122.5 volts, 60 Hz to 245 volts, 90 Hz to 331 volts, 120 Hz to 417 volts, 135 Hz to 460 volts, and a linear interpolation of operating frequencies and operating voltages therebetween.

18. The method of claim 10, the electric motor being disposed to provide rotational force to a component of an air conditioning system.

19. A method of reducing an amount of electrical energy consumed by electric motor driven equipment, the method comprising:
identifying a first electric motor used to drive equipment, the first electric motor having a first nameplate horsepower rating and having a first number of sets of electromagnetic windings; and
operating a second electric motor, in place of the first, the second electric motor having a second nameplate horsepower rating, and a second number of sets of electromagnetic windings, the first nameplate horsepower rating being at least about twice that of the second nameplate horsepower rating, and the second number of sets of electromagnetic windings being at least twice that of the first number of sets of electromagnetic windings, the second electric motor also having a nameplate operating frequency, a first wiring configuration, and a second wiring configuration, the first wiring configuration for operating at a first nameplate voltage and the second wiring configuration for operating at a second nameplate voltage, the first nameplate voltage being lower than the second nameplate voltage;
the operating the second electric motor comprising operating the second electric motor in the first wiring configuration at a frequency above the nameplate frequency and a voltage above the first nameplate voltage.

20. The method of claim 19, the operating the second electric motor further comprising operating the second electric motor at a selected frequency and a determined voltage, the voltage being determined based on a set of operating frequency versus operating voltage ratios over a range of operating frequencies in which a first ratio in a lower portion of the frequency range is lower than a second ratio in a middle portion of the frequency range, and a third ratio in an upper portion of the frequency range is lower than the second ratio, the range of operating frequencies extending from a first frequency below the nameplate operating frequency to a second frequency above the nameplate operating frequency, and the corresponding range of operating voltages extending from a first voltage below the first nameplate voltage to a second voltage above the first nameplate voltage.

21. The method of claim 19, further comprising providing the second electric motor.

22. The method of claim 19, the second electric motor further comprising motor bearings designed for operating the second electric motor at an operational rotational speed above a rotational speed that corresponds to the nameplate frequency.

23. The method of claim 19, the second electric motor further comprising a rotor, the rotor being balanced for operating the second electric motor at an operational rotational speed above a rotational speed that corresponds to the nameplate frequency.

24. The method of claim 19, the second electric motor further comprising a rotor, the rotor having windings, the windings having a winding density that provides the second electric motor with a selected breakdown torque value at operational rotational speeds above a rotational speed that corresponds to the nameplate frequency, the selected breakdown torque value being equal to or greater than a value determined by multiplying the second nameplate horsepower rating by a torque per horsepower value based on the second number of sets of electromagnetic windings.

25. The method of claim 24, the selected breakdown torque value being equal to or greater than 150% of a value determined by multiplying the second nameplate horsepower rating by a torque per horsepower value based on the second number of sets of electromagnetic windings.

26. The method of claim 19, the first electric motor comprising a first insulation system having a first temperature tolerance rating and the second electric motor comprising a second insulation system having a second temperature tolerance rating, the second temperature tolerance rating having a higher maximum operation temperature than that of the first temperature tolerance rating.
